(19) United States
(12) Patent Application Publication
(10) Pub. No.: US 2008/0021829 A1
(43) Pub. Date: Jan. 24, 2008

(54) RULE-BASED SELECTION OF FINANCIAL ACCOUNT FOR PAYMENT CARD TRANSACTION

(76) Inventor: Arthur D. Kranzley, Pound Ridge, NY (US)

Correspondence Address: BUCKLEY, MASCHOFF & TALWALKAR LLC, 50 LOCUST AVENUE, NEW CANAAN, CT, 06840, US

(21) Appl. No.: 11/773,599

(22) Filed: Jul. 5, 2007

Related U.S. Application Data
(60) Provisional application No. 60/818,895, filed on Jul. 6, 2006.

(51) Int. Cl. G06Q 40/00; G06F 17/30; G06F 17/40

(52) U.S. Cl. 705/44

(57) ABSTRACT

A method of operating a payment card system includes receiving, from a card holder, information indicative of at least one attribute of an account selection rule. The account selection rule is stored in a database. A request to authorize a payment card transaction is received. In response to the request, the stored account selection rule is retrieved. The method further includes selecting among a plurality of accounts belonging to the card holder based at least in part on the retrieved account selection rule. The selected account is used for the requested payment card transaction.

### CROSS-REFERENCE TO RELATED APPLICATION

This application claims the benefit of U.S. Provisional Patent Application Ser. No. 60/818,895, filed Jul. 6, 2006, which is incorporated herein in its entirety.

### BACKGROUND

There have been proposals to use one payment card, in the general form of a conventional credit card or debit card, for access to more than one financial account. In many cases, such proposals have called for payment cards having features beyond those present in the types of payment cards that are in widespread use. Accordingly, many of the proposals would result in increased costs for the manufacturing of payment cards. Also, the mechanisms provided in these proposals for cardholders to select among the financial accounts accessible with a single multi-purpose payment card are often complicated or confusing.

It would be desirable to provide a system that allows cardholders to access multiple financial accounts with a single payment card in a manner which is convenient and flexible for the cardholders. It would be particularly advantageous if such a system operated with payment cards that are structurally and functionally the same as payment cards that are typically used in existing widely-deployed payment card systems.

### BRIEF DESCRIPTION OF THE DRAWINGS

FIG. 1 is a block diagram representation of a payment card system provided according to some embodiments.

FIG. 2 is a block diagram of a server computer employed by a payment card association in the system of FIG. 1.

FIG. 3 is a schematic tabular representation of an account selection rule database that is associated with the server computer of FIG. 2.

FIG. 4 is a flow chart that illustrates a process that may be performed by the server computer of FIG. 2.

FIG. 5 is a flow chart that illustrates a process that may be performed in the system of FIG. 1.

### DETAILED DESCRIPTION

In general, and for the purpose of introducing concepts of embodiments of the present invention, a payment card system allows cardholders to use a single payment card to provide access to more than one financial account. The system permits cardholders to pre-define, and to store in the system, account selection rules which are associated by the system with the cardholder's card number. For example, the rules may determine which account should be selected for use in a particular transaction based on one or more attributes of the transaction. When the cardholder presents his/her card to pay for a transaction, the system looks up the rule or rules, previously defined by the cardholder, to determine which one of the cardholder's accounts should be accessed to pay for the transaction.

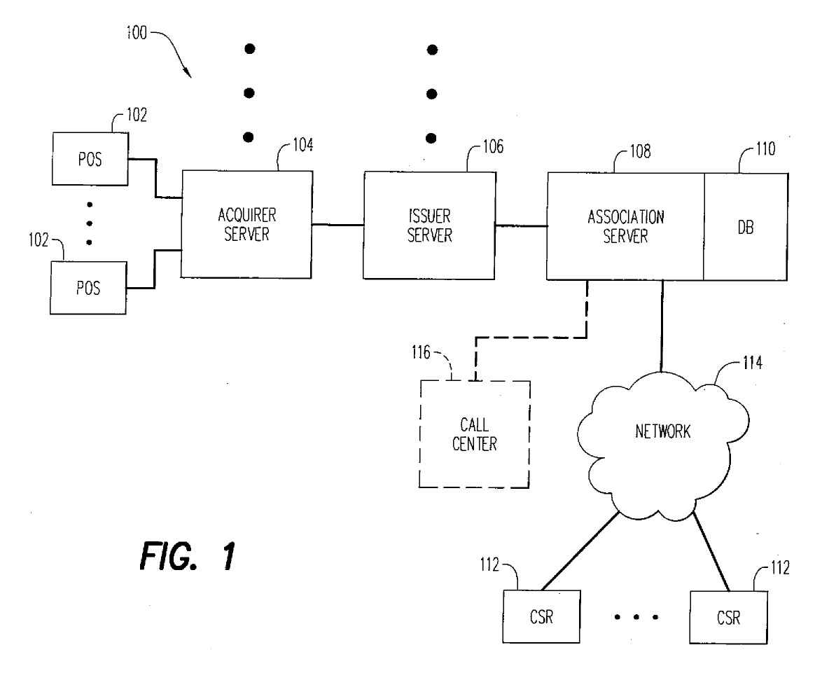

FIG. 1 is a block diagram representation of a payment card system 100 provided according to some embodiments.

The payment card system 100 includes point-of-sale terminals 102 which are located at various retail establishments. The point-of-sale terminals 102 include magnetic stripe card readers, proximity coupling devices and/or other peripheral devices (all not separately shown) which allow the point-of-sale terminals to receive payment card numbers from payment cards (not shown) presented to the point-of-sale terminals 102 by cardholders to pay for transactions. The payment cards may be identical to conventional credit or debit cards, for example. After reading or otherwise receiving a payment card number, a point-of-sale terminal 102 submits a request for authorization of the transaction. The request for authorization typically includes the payment card number, the amount of the transaction, the identity of the merchant which operates the point-of-sale terminal, and other information. In some embodiments, the point-of-sale terminals 102 may operate entirely in a conventional manner.

The payment card system 100 may also include numerous server computers 104 (of which only one is explicitly shown) operated by “acquiring” financial institutions which have contracted with the merchants to receive and process the merchants' payment card transactions. The acquirer server computers 104, in turn, pass the transaction requests on to server computers 106 (only one explicitly shown), which are operated by financial institutions which issued the payment cards. The issuer server computers 106 are also part of the payment card system 100. The issuer server computers 106 process the transaction requests received from the acquirer server computers 104 and determine whether the requested transactions are to be authorized.

The payment card system may further include a server computer 108 that is operated by a payment card association, such as MasterCard International Incorporated, the assignee hereof. In some embodiments, a database 110 of account selection rules is associated with the server computer 108. Both the server computer 108 and the database 110 will be described in greater detail below. As will be seen, for a given transaction request, an issuer server computer 106 and the association server computer 108 may exchange communications to determine a particular financial account to which the transaction is to be charged. The particular financial account may be selected from among a number of different accounts associated with an individual who presented a payment card in connection with the transaction.

The payment card system 100 may also include customer devices 112, which interact with the association server 108 from time to time via a communication network 114 such as the Internet. The customer devices may be, for example, personal computers, laptop computers, web-enabled cellular telephones, etc. As will be seen, customers who hold or are applying for payment cards branded by the payment card association are permitted to submit information to the server computer 108 to define rules that are applied to each of the customers' payment card transactions to determine which account is to be used for the transaction in question.

In addition or alternatively, the payment card system may include a call center 116. The call center 116 may be staffed by human operators who take telephone calls from customers (in addition or alternatively the call center may include an automatic voice response unit). The call center human operators may receive information from the customers to define account selection rules, and then input the information to the server computer 108 so that the account selection rules are stored in the database 110.

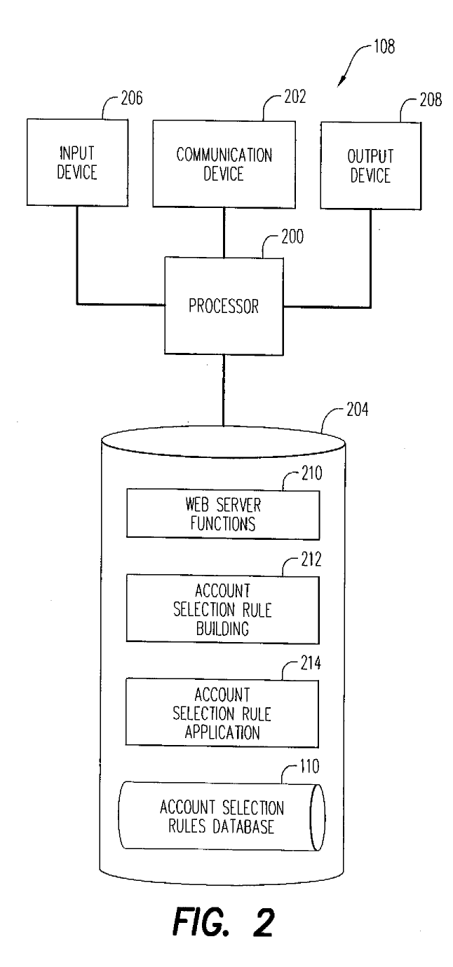

FIG. 2 is a block diagram of the payment card association server computer 108 as provided in accordance with some embodiments. The server computer 108 may include a computer processor 200 operatively coupled to a communication device 202, a storage device 204, an input device 206 and an output device 208.

The computer processor 200 may be constituted by one or more conventional processors, and may, for example, comprise RISC-based or other types of processors. Processor 200 operates to execute processor-executable process steps so as to control the server computer 108 to provide desired functionality.

Communication device 202 may be used to facilitate communication with, for example, other devices (such as customer devices 104, issuer servers 106 and/or personal computers or terminals/workstations (not shown) operated by human operators at the call center 116). Communication device 202 thus may include numerous ports to allow for simultaneous communication with a number of other devices. Communication device 202 is therefore preferably configured with hardware suitable to physically interface with desired external devices and/or network connections. For example, communication device 202 may comprise an Ethernet connection to a local area network through which the server computer 108 may receive and transmit information over the Internet. In addition or alternatively, the communication device 202 may couple the server computer 108 to one or more private communication networks by which the server computer 108 may communicate with issuer servers 106.

Input device 206 may comprise, for example, a keyboard, a keypad, a mouse or other pointing device, a microphone, knob or switch, an infra-red (IR) port, a docking station, and/or a touch screen. Output device 208 may comprise, for example, a display (e.g., a display screen), a speaker, and/or a printer.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory.

Storage device 204 stores one or more programs for controlling processor 200. The programs comprise processor-executable process steps of server computer 108, including process steps that constitute processes provided in accordance with principles of the present invention, as described in more detail below. Processor 200 performs instructions of the programs, and thereby operates in accordance with the present invention.

The programs may include one or more applications 210 that cause the server computer 108 to operate as a web server to handle access requests from customer devices 112. In addition the programs may include one or more applications 212 that solicit and receive input from customer devices 112 as required to define account selection rules. Details of the account selection rule building application 212 will be discussed below.

In addition, the programs may include an application program 214 that responds to specific transaction requests by applying one or more account selection rules to the requests to select accounts to be used for the transactions. Details of the application program for applying account selection rules will be discussed below.

Any or all process steps of the programs stored in the storage device 204 may be read from a computer readable medium, such as a floppy disk, a CD-ROM, a DVD-ROM, a Zip™ disk, a magnetic tape, or a signal encoding the process steps, and then stored in a compressed, uncompiled and/or encrypted format. Processor-executable process steps being executed by processor 200 may typically be stored temporarily in RAM (not separately shown) and executed therefrom by processor 200. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

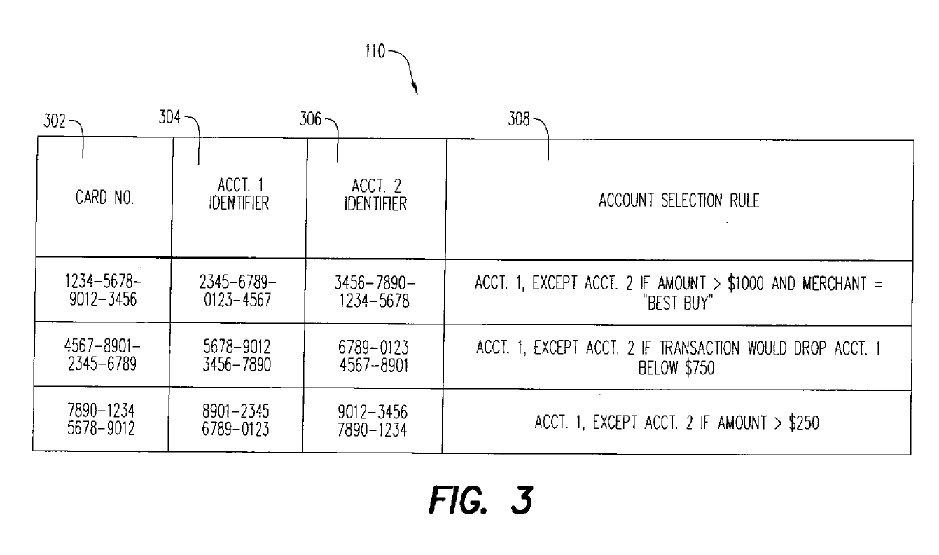

Storage device 204 may also store the database 110 (referred to above in connection with FIG. 1) in which account selection rules defined by customers are stored. Other databases may also be provided. An example of the account selection rules database 110 is described below in conjunction with FIG. 3. Those skilled in the art, upon reading this disclosure, will understand that a number of different forms of account selection rules data may be utilized.

There may also be stored in storage device 204 other unshown elements that may be necessary for operation of the payment card association server 108, such as an operating system, a database management system, other applications, other data files, and “device drivers” for allowing processor 200 to interface with devices in communication with communication device 202. These elements are known to those skilled in the art, and therefore are not described in detail herein.

Referring now to FIG. 3, a table shown in that drawing represents exemplary entries for the account selection rules database 110. As will be understood by those skilled in the art, the schematic illustration shown in FIG. 3 and the following description of the exemplary entries are exemplary arrangements for stored representations of information. A number of other arrangements may be employed besides that suggested by the table shown. Similarly, the illustrated entries of the database 110 represent exemplary information only. Those skilled in the art will understand that the number and contents of the entries can be different from those illustrated. In a practical embodiment, the number of entries in the account selection rules database 110 may be in the thousands, or even in the millions.

As depicted, the table of FIG. 3 defines a number of fields 300, 302, 304 and 306. Each entry corresponds to a respective payment card number borne by a particular payment card issued with the brand of the payment card association which operates the server computer 108. In some embodiments, there are entries in the database 216 only with respect to payment cards for which customers have defined at least one account selection rule. The fields shown in FIG. 3 specify: payment card number 302, identifier 304 for a first account associated with the respective payment card number, identifier 306 for a second account associated with the respective payment card number, and rule 308 to be applied to transactions for the payment card in question for the purpose of selecting between the two accounts associated with the payment card number.

For convenience of presentation, the account selection rules database 216 is shown as having only four fields. However, in practice additional fields may be present, such as cardholder name, cardholder address, other fields for additional cardholder contact information, cardholder social security number, etc. Moreover, the account selection rules database may generally be integrated with cardholder/payment card databases used for other purposes in addition to selection among accounts for use in a particular requested transaction. Further, it is not required that the number of accounts associated with a payment card number be limited to two accounts. Accordingly, the number of account identifier fields may be in excess of the two fields 304, 306 shown in the drawing.

Although in the example entries shown, the two account identifiers associated with each payment card number are different from the payment card number, it may alternatively be the case that at least for some entries one of the account identifiers may be the same as the respective payment card number.

As to the acquirer server computer(s) 104 and the issuer server computer(s) 106, both (all) may be constructed of conventional hardware, which may be similar to the hardware aspects of the payment card association server computer 108, as described above. The acquirer server computer may operate entirely in accordance with conventional principles. The issuer server computer may operate partly in accordance with aspects of the present invention, as described below.

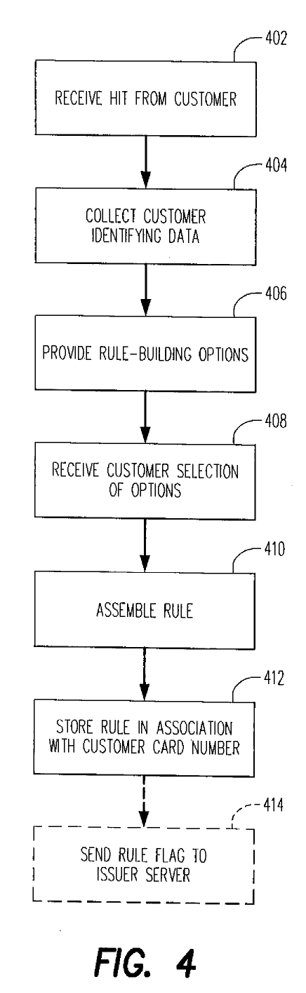

FIG. 4 is a flow chart that illustrates a process that may be performed by the payment card association server computer 108.

At 402 in FIG. 4, a customer accesses a webpage that is hosted by the server computer 108 and provided to allow customers to define account selection rules. At 404 the server 108 prompts the customer to provide, and receives from the customer, data which identifies the customer and/or the customer's payment card number and/or account number or numbers. Verification of the customer's identity may be performed by password or in any suitable manner. If the customer has more than one payment card/payment card number, this step may also entail the customer selecting for which payment card number he/she wishes to define an account selection rule

At 406, the server 108 provides to the customer one or more options for defining an account selection rule to be stored in association with the customer's payment card number. For example, one option may allow the customer to designate one account as primary and another account as secondary. As another example, another option may inquire of the customer as to whether the customer desires account selection to be based on the dollar amount of the transaction. If the customer indicates “yes”, then a follow-up option may allow the customer to specify the particular transaction dollar amount to be included in the account selection rule.

In another option, the customer may be asked to indicate whether account selection should be based on the identity of the merchant or the category of the merchant at which the transaction is taking place. If the customer responds affirmatively, then a follow up option or options may allow the customer to specify a category of merchant or to identify one or more merchants as criteria for the account selection rule.

Other options may allow customers to combine criteria, such as dollar amount plus merchant category or merchant identity, in one rule.

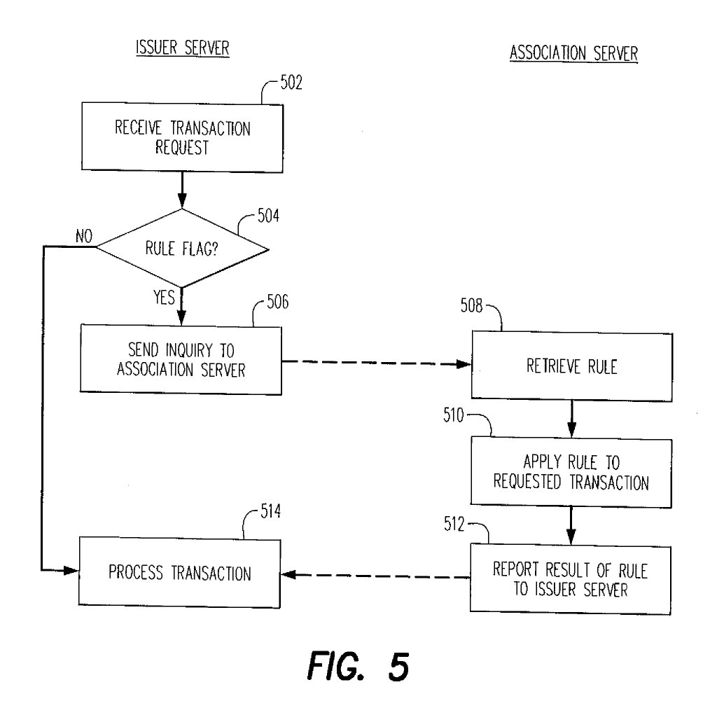

At 408 (which may be interspersed with 406), the server computer 108 receives input from the customer to indicate selection of one or more of the options offered at 406. In this way the server computer receives from the customer information which indicates one or more criteria or other attributes of the account selection rule which the customer is defining. Once the server computer 108 has received all of the information needed to define an account selection rule in accordance with the customer's wishes, the server computer assembles the desired rule, as indicated at 410. The server computer 108 then stores the account selection rule in the database 110, as indicated at 412. At this point, and as indicated in phantom at 414, the server computer may interact with the server computer 106 for the issuer of the customer's payment card to flag the respective payment card number as having an account selection rule applicable thereto. A function of the resulting “rule flag” will be described below in conjunction with FIG. 5.

At least some of the functions described in FIG. 4 may be implemented by customer interaction with a rule definition “wizard” that is provided by the payment card association server computer. Also, in some embodiments, after the customer identifies himself/herself, it may be necessary or desirable for the payment card association server computer to exchange one or more messages with one or more issuer server computers to obtain information about accounts that the customer holds.

In connection with FIG. 4, rule definition has been described in connection with customer access by Internet to a website maintained by or on behalf of a payment card association. In addition or alternatively, and as suggested by the above discussion of the call center 116, a customer may call in to a call center to provide rule definition information to a human operator at the call center. The human operator may enter data into the system to define account selection rules in accordance with the customer's input. An AVRU (automatic voice response unit) is another alternative vehicle by which customer input may be collected to define account selection rules.

Particular examples of account selection rules will now be discussed.

According to one type of account selection rule, the customer may elect that all transactions below a given dollar amount be charged to one account, with all transactions at or above that dollar amount being charged to a different account. In this way, relatively large transactions (say above $250) can be easier for the cardholder to track since they are segregated from smaller transactions.

According to another type of account selection rule, all transactions at a particular retailer or type of retailer may be charged to one account, and all other transactions charged to a different account. For example, the customer may elect that one account be reserved only for transactions at hardware stores, with all such transactions being charged to that account, and all other transactions being charged to a different account.

According to yet another type of account selection rule, both the transaction amount and the identity or type of the merchant may determine to which account the transaction is charged.

According to still another type of account selection rule, a transaction is to be charged to a debit card account, unless the charge would reduce the account balance below a certain predetermined amount (say $500). If the latter condition is satisfied (i.e., if charging the transaction to the debit card account would reduce the account balance below the predetermined amount), then the transaction is instead charged to a credit card account.

FIG. 5 is a flow chart that illustrates a process that may be performed in the payment card system 100 with respect to a particular payment card transaction.

At 502, it is assumed that an issuer server computer 106 has received a request to authorize a payment card transaction from an acquirer server computer 104. It will be appreciated that the transaction request may have originated from one of the point-of-sale terminals 102. The transaction request may include information such as the card number of the payment card submitted for the transaction, the amount of the transaction, the identity of the merchant, etc.

At 504, the issuer server computer 106 determines whether a “rule flag” has been stored with respect to the payment card number included in the transaction request. As discussed above, the “rule flag” indicates that an account selection rule has previously been created for the payment card number in question and that action should be taken to apply the account selection rule.

If it is determined at 504 that a “rule flag” applies to the payment card number, then, as indicated at 506, the issuer server computer 106 sends an inquiry to the payment card association server computer 108 to allow the payment card association server to apply the applicable account selection rule. The inquiry sent by the issuer server computer 106 to the payment card association server computer 108 may include any and all information required to apply an account selection rule to the transaction, including for example the payment card number, the amount of the transaction and the identity of the merchant.

At 508, the payment card association server computer 108 responds to the inquiry from the issuer server computer 106 by retrieving one or more account selection rules that have been stored in the account selection rule database 110 with respect to the payment card number for the payment card presented in connection with the transaction. The payment card association server computer then, at 510, makes a determination as to which of the cardholder's accounts should be charged for the transaction, based on the retrieved account selection rule, and on the information contained in the inquiry from the issuer server computer. Thus, based on the account selection rule and information about the transaction, the payment card association server computer selects an account to be used for the transaction from among the accounts of the cardholders At 512, the payment card association server computer provides a response to the issuer server computer by indicating which account of the cardholder is to be used for the transaction.

At 514, the issuer server computer processes the requested transaction by charging and/or authorizing the transaction to the account determined by the payment card association server computer in accordance with the retrieved account selection rule.

Considering again the determination made at 504 in FIG. 5, if it is found that no rule flag is applicable to the presented payment card number, then the issuer server computer processes the transaction in a conventional manner, using the account indicated by the payment card number.

With the system illustrated in the drawings, cardholders are permitted to pre-define account selection rules so that the cardholder can access more than one account with a single payment card. Which account is accessed for a particular transaction is determined by the payment card system based on one or more considerations that are selected ahead of time by the cardholder. In some embodiments, the cardholder is allowed to access the system (e.g., via the Internet) at any time to cancel or modify one or more account selection rules that the cardholder had previously defined.

The functions described herein may be divided among the system components in various ways, and the system may be modified while continuing to operate in accordance with principles of the present invention. For example, the payment card association server computer could be eliminated, with each issuer server computer (or at least some of the issuer server computers) taking on functions of the payment card association server computer such as receiving input from cardholders (or prospective cardholders) to define account selection rules, storing the resulting account selection rules, and applying the account selection rules to transaction requests.

According to another, less radical, modification, the “rule flag” may be dispensed with, and the issuer server computer may query the payment card association server computer with respect to every transaction to allow for application at the payment card association server computer of an account selection rule, if such exists for the payment card number in question. In cases where an account selection rule exists, the payment card association server applies the rule to select an account and informs the issuer server of the selected account. When no account selection rule exists for the presented payment card number, the payment card association server computer so informs the issuer server computer, which then uses the account indicated by the presented payment card number.

In another modification of the system, the payment card association server computer operates to receive cardholder (or prospective cardholder) input to define account selection rules, and then downloads the rules to the issuer server computers for the cardholders. The issuer server computers then store the account selection rules and apply the rules to transaction requests.

The invention has been described up to this point in connection with a payment card system branded by a national payment card association. However, as an alternative, the present invention may be implemented at least partially in a proprietary payment card system operated by or on behalf of a particular retailer. Thus, for example, a customer of the retailer may have both a revolving credit account and an installment account. The retailer's proprietary system may allow the customer to define a rule such as, “Charge purchases of less than $300 to my revolving credit account; charge purchases of $300 or more to my installment line of credit”. Both accounts may be automatically accessible according to this rule by use of a single payment card issued by or on behalf of the retailer.

According to other modifications of the payment card system of the present invention, at least some functions relating to creation, storage and/or application of account selection rules may be assigned to one or more acquirer server computers.

In some embodiments, the functions of the payment card association server computer may be divided among two or more computers, of which one or more may or may not be operated by or on behalf of the payment card association. For example, one server computer may operate to receive customer input to define account selection rules, and another computer may receive the rules from the first computer, store the rules, and apply the rules in response to inquiries from issuer server computers.

A system like that shown in FIG. 1 may also operate to provide cardholders with alerts and/or reminders relating to their use of financial accounts. Dispatching of alerts/reminders may be triggered by rules similar to account selection rules. Alert/reminder rules may be defined in a similar manner to account selection rules, and by a process similar to that described above with respect to FIG. 4.

The following is a concrete example of an alert rule: “Send me an alert any time my purchases at Starbucks exceed $50 in a single calendar month.” An alert of this type may aid a cardholder in avoiding overindulgence of a particular kind of expenditure. To implement such a rule, the payment card association server computer may track the cardholder's purchases at the designated retailer and may issue alerts via channels such as electronic mail or by text messaging to the cardholder's cellular telephone.

Another possible alert rule could take the form of: “Send me an alert any time one of my transactions is for $500 or more.” This type of rule may flag large unauthorized purchases for the cardholder, and thus may assist the cardholder in early detection of fraudulent transactions.

The flow charts and process descriptions herein should not be understood to imply a fixed order of performing process steps. Rather, the process steps may be performed in any order that is practicable.

As used herein and in the appended claims, the term “payment card” should be understood to refer not only to card shaped items bearing magnetic stripes but also to other devices, whether or not card shaped, used to input an identification number for accessing a financial account. Thus “payment card” also includes devices that report account access identification information by proximity coupling, radio frequency identification (RFID) techniques, and the like.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method of operating a payment card system, the method comprising:
receiving, from a card holder, information indicative of at least one attribute of an account selection rule;
storing the account selection rule;
receiving an indication of a request to authorize a payment card transaction;
in response to the indication of the request, retrieving the stored account selection rule;
selecting, based at least in part on the retrieved account selection rule, among a plurality of accounts belonging to the card holder; and
using the selected account for the payment card transaction.

2. The method of claim 1, wherein the selecting among the accounts is based at least in part on a merchant identifier included in the request.

3. The method of claim 2, wherein the selecting among the accounts is based at least in part on a dollar amount of the transaction.

4. The method of claim 1, wherein the selecting among the accounts is based at least in part on a dollar amount of the transaction.

5. The method of claim 1, wherein the plurality of accounts includes a plurality of credit card accounts.

6. The method of claim 1, wherein the plurality of accounts includes a credit card account and an installment line of credit.

7. A method of operating a payment card system, the method comprising:
receiving, from a customer, information indicative of at least one attribute of an account selection rule; and
storing the account selection rule in association with a payment card number that corresponds to a payment card issued or appointed for issuance to the customer.

8. The method of claim 7, wherein the account selection rule is stored in a database in a server computer.

9. The method of claim 8, further comprising:
retrieving the account selection rule from the database in response to an indication of a request to authorize a payment card transaction for the customer.

10. The method of claim 9, wherein the server computer associates a plurality of accounts with the payment card number, said account selection rule for selecting among the plurality of accounts, the method further comprising:
using the retrieved account selection rule to select among the plurality of accounts associated with the payment card number.

11. The method of claim 7, wherein the information indicative of at least one attribute of an account selection rule is received via a web server computer.

12. The method of claim 7, wherein the information indicative of at least one attribute of an account selection rule is received via a human operator at a call center.

13. An apparatus comprising:
a server computer; and
a database coupled to the server computer;
the server computer comprising:
first means for receiving, from a card holder, information indicative of at least one attribute of an account selection rule;
second means for storing the account selection rule in the database;
third means for receiving an indication of a request to authorize a payment;
fourth means, responsive to the third means, for retrieving the account selection rule from the database;
fifth means, responsive to the fourth means, for selecting, based at least in part on the retrieved account selection rule, among a plurality of accounts belonging to the card holder; and
sixth means, responsive to the fifth means, for identifying the selected account for use in the payment card transaction.

14. The apparatus of claim 13, wherein the fifth means selects among the accounts based at least in part on a merchant identifier included in the request.

15. The apparatus of claim 13, wherein the fifth means selects among the accounts based at least in part on a dollar amount of the transaction.

16. An apparatus comprising:
a server computer; and
a database coupled to the server computer;
the server computer comprising:
first means for receiving, from a customer, information indicative of at least one attribute of an account selection rule; and
second means, responsive to the first means, for storing the account selection rule in the database in association with a payment card number that corresponds to a payment card issued or appointed for issuance to the customer.

17. The apparatus of claim 16, wherein the server computer further comprises:
third means for retrieving the account selection rule from the database in response to an indication of a request to authorize a payment card transaction for the customer.

18. The apparatus of claim 17, wherein the server computer associates a plurality of accounts with the payment card number, said account selection rule for selecting among the plurality of accounts, the server computer further comprising:
fourth means, responsive to the third means, for using the retrieved account selection rule to select among the plurality of accounts associated with the payment card number.

19. The apparatus of claim 16, wherein the information indicative of at least one attribute of an account selection rule is received via a web server computer.

20. The apparatus of claim 16, wherein the information indicative of at least one attribute of an account selection rule is received via a human operator at a call center.
